(19) United States
(12) Patent Application Publication
(10) Pub. No.: US 2011/0057006 A1
(43) Pub. Date: Mar. 10, 2011

(54) MULTI-PURPOSE MOUNT FOR PORTABLE COMPUTERS

(76) Inventor: GARY L. SMITH, El Paso, TX (US)

(21) Appl. No.: 12/858,212

(22) Filed: Aug. 17, 2010

Related U.S. Application Data
(60) Provisional application No. 61/272,319, filed on Sep. 10, 2009.

(51) Int. Cl. B60R 7/00; F16M 13/00

(52) U.S. Cl. 224/276; 248/309.1; 248/274.1

(57) ABSTRACT

The multi-purpose mount for portable computers is removably installable upon a motor vehicle steering wheel or other mounting surface to support a portable computer (e.g., a laptop computer) thereon. The mount includes a base for supporting the computer and a back for supporting the screen, the back having a pair of hooks extending therefrom to secure the device removably to the steering wheel. A mechanism allows the maximum open angle between the base and back to be adjusted. The base and the back may be folded together for storage with the closed laptop remaining installed within the device. Accessories may include a mouse pad removably installable to one side of the base and a folding sunshade removably installable to the top of the back. A caddy or holder may be provided for the storage of the mount with the computer remaining installed therein.

### CROSS-REFERENCE TO RELATED APPLICATION

This application claims the benefit of U.S. Provisional Patent Application Ser. No. 61/272,319, filed Sep. 10, 2009.

### BACKGROUND OF THE INVENTION

1. Field of the Invention

The present invention relates generally to mounts, brackets, and attachments for temporarily supporting an article from another object, and more particularly to a multi-purpose mount for portable computers, allowing the computer to be suspended and deployed for use from the steering wheel of a vehicle or other convenient base.

2. Description of the Related Art

It is well known that advances in microelectronics have led to the development of relatively small computing devices that are sufficiently lightweight and portable as to be carried and used virtually anywhere. Such devices, i.e., laptop, notebook, and tablet computers and the like, have proven to be extremely important business and entertainment tools for perhaps most people, with business people being at a distinct disadvantage if they are unable to use a computer on the job.

The portability of such devices has resulted in their being carried into the field by sales personnel to place and record orders, track sales, check on availability of orders, etc. Contractors also frequently use portable computers to make notes, work up estimates, and perform other tasks critical to the job at hand. Many other professionals also rely upon their personal computers for various purposes, both in the home and office and while traveling.

While it is obviously not reasonable or safe to use a personal computer while operating a motor vehicle, the need frequently occurs to use such a computer from a parked motor vehicle in the field. Clearly, it is most convenient to use the computer from the passenger side of the vehicle, where there is more room. However, this is not always a suitable option for the driver and computer user. There may be a passenger in that seat, or perhaps other articles of equipment that are at best inconvenient to move. Moreover, many times it is inconvenient for the driver and computer operator to relocate to the passenger seat due to an intervening console or other structure, and the driver/computer operator only needs to use the computer for a short time.

Thus, a multi-purpose mount for portable computers solving the aforementioned problems is desired.

### SUMMARY OF THE INVENTION

The multi-purpose mount for portable computers has a base with a back pivotally secured thereto. The base and back are preferably constructed of aluminum or other metal angle extrusions and plates to provide the desired qualities of strength and light weight. A mechanism is provided between the base and back to allow the maximum open angle between the base and back to be adjusted as desired. The base provides support for a conventional portable computer (e.g., a laptop computer), and includes means for removably securing the computer positively to the base. The back of the device serves to support the screen of the computer when opened, with the opposite side of the back having a pair of hooks extending therefrom for removably securing the device to the steering wheel of a motor vehicle. Other accessories may be provided with the computer holder or mount. A mouse pad may be added to one side of the base, if so desired. The base may be provided with a pair of “keyhole” slots in the side thereof. The mouse pad has a corresponding pair of pins or bolts extending from the edge thereof to engage the slots in the base. Additionally, a sunshade may be removably attached to the top of the back structure to extend over the computer screen when deployed.

The multi-purpose mount may be folded when not in use. The back folds substantially parallel to the base. The portable computer may remain in place between the base and back of the mount when they are folded. A caddy or holder may also be provided for the folded mount and computer therein. The caddy also provides storage for the folded sunshade. The caddy may be secured in an unused seat using the conventional seatbelt provided or, alternatively, may be secured to a central console, or merely placed upon the floor of the vehicle, as desired.

While the multi-purpose mount is directed primarily for the support of a laptop computer or the like from the steering wheel of a vehicle, the device may also be used for the support of such an electronic device in other environments as well, e.g., home, office, school, or various public locations. The mount provides greater comfort for the user than would be the case when the computer is placed directly upon the lap of the user, and the spacing from other structures greatly improves ventilation for the computer for greater comfort for the user and greater reliability for the computer.

These and other features of the present invention will become readily apparent upon further review of the following specification and drawings.

### BRIEF DESCRIPTION OF THE DRAWINGS

FIG. 1 is a perspective view of a multi-purpose mount for portable computers according to the present invention, shown deployed upon a steering wheel and holding a portable computer therein for use.

FIG. 2 is an exploded perspective view of the multi-purpose mount for portable computers of FIG. 1, showing its general construction.

FIG. 3 is a right side elevation view of the assembled multi-purpose mount of FIGS. 1 and 2, showing the angular adjustment between the base and the screen support.

FIG. 4 is a perspective view showing the multi-purpose mount of FIG. 1 with folded computer therein, stored in a caddy or holder.

Similar reference characters denote corresponding features consistently throughout the attached drawings.

### DETAILED DESCRIPTION OF THE PREFERRED EMBODIMENTS

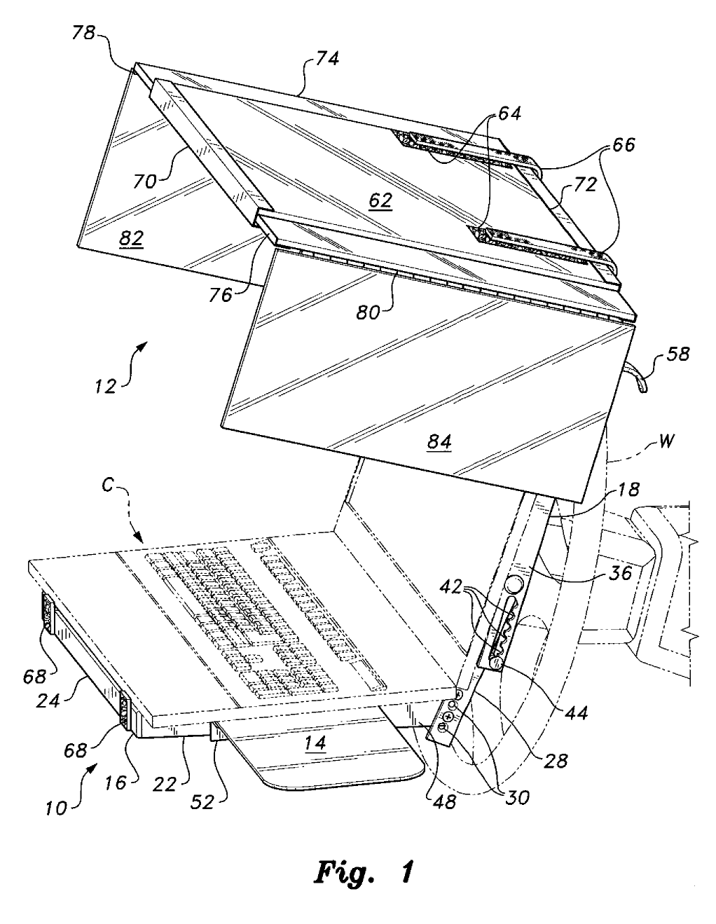

The present invention is a multi-purpose mount for supporting a portable computer (e.g., laptop, etc.) from the steering wheel of a motor vehicle, or from any other suitable mounting surface. FIG. 1 of the drawings provides an environmental perspective view of the deployed multi-purpose mount for portable computers 10, with a portable computer C shown thereon in broken lines. FIG. 1 also illustrates additional accessories that may be provided and used with the mount 10, i.e., a sunshade 12 and removably installed mouse pad 14.

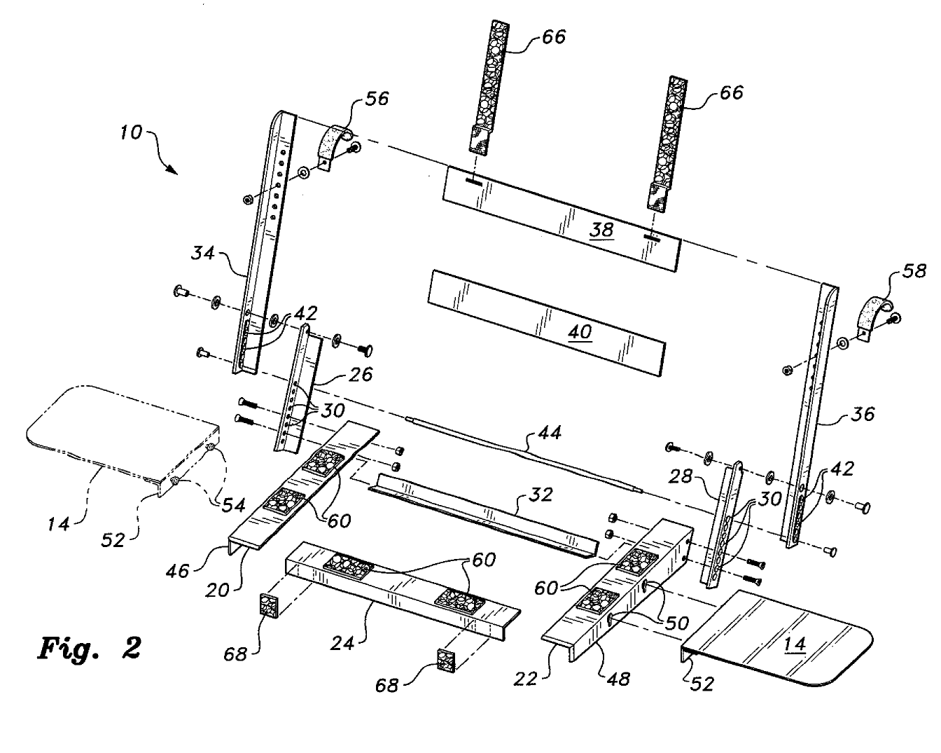

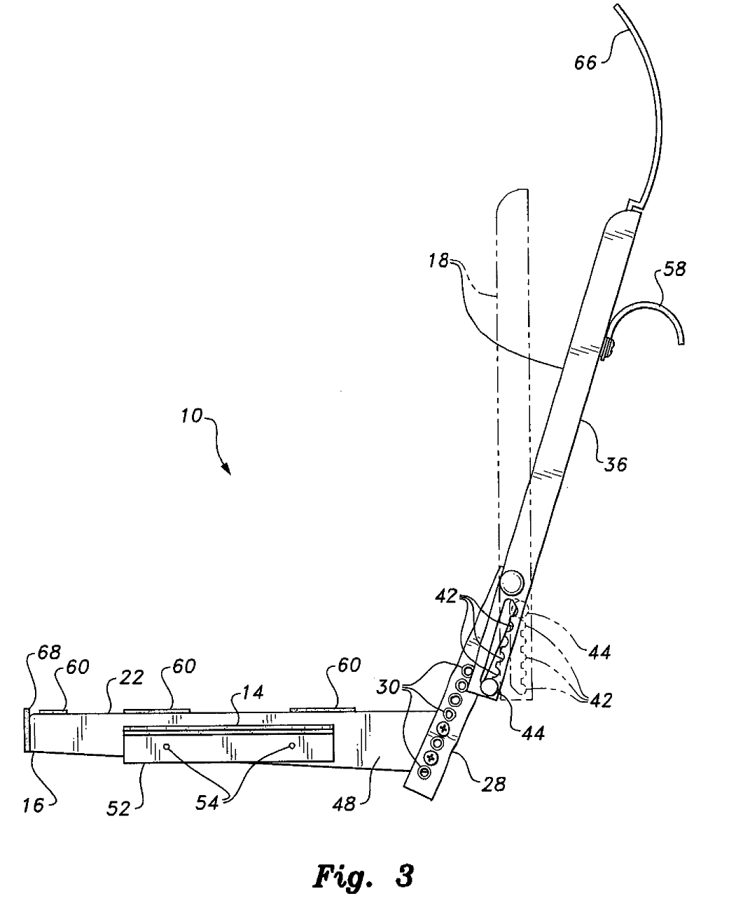

FIG. 2 provides an exploded perspective view of the various components comprising the multi-purpose mount 10, as well as showing alternative positions for the mouse pad 14. The mount 10 includes a base 16 with a back 18 pivotally extending therefrom, generally as shown in FIGS. 1 and 3 of the drawings. The base 16 includes mutually opposed first and second side members, respectively 20 and 22, with a forward crossmember 24 connecting the forward ends of the two side members 20 and 22.

First and second extension members, respectively 26 and 28, are affixed to the rearward ends of the respective side members 20 and 22, and extend upwardly and slightly rearwardly therefrom. The extension members 26, 28 may be permanently and immovably affixed (e.g., welded, etc.) to the rearward ends of the two side members 20 and 22 of the base 16, if so desired. However, the extension members illustrated in FIGS. 1 through 4 will be seen to have a plurality of attachment passages 30 formed therethrough, allowing some adjustment in the positioning or attachment of the extension members 26 and 28 to their respective base side members 20 and 22. A rear crossmember 32 connects the lower ends of the two extension members 26, 28 to provide a more rigid structure for the base 16.

The back 18 includes mutually opposed and parallel first and second side members, respectively 34 and 36, pivotally attached respectively to the first and second extension members 26 and 28 of the base 16. At least an upper crossmember 38 connects the two side members 34, 36, with a medial crossmember 40 also being shown in FIG. 2. The angle between the base 16 and the rigid back assembly 18 is thus adjustable as desired by means of the pivotal attachment of the two side members 34, 36 of the back 18.

It will be seen that the pivotal attachment of the side members 34, 36 to the respective extensions 26, 28 is somewhat above the lowermost ends of the side members. A slot having a series of adjustment notches 42 therein is formed in each of the extensions 26 and 28, below the pivot attachment thereof. A stop rod 44 is secured laterally across the back 18, through the two slots of the side members 34 and 36. This stop 44 may be selectively placed in any two corresponding notches 42, and bears against the backs of the side members 34 and 36 when the back 18 is completely opened relative to the base 16. This adjustment of the maximum angle between the base 16 and back 18 is shown clearly in FIG. 3 of the drawings. The stop rod 44 is shown placed in the lowermost notch pair in solid lines in FIG. 3, thus allowing the lower portions of the side members 34, 36 to pivot closer to their corresponding extensions 26, 28 before the rod 44 contacts the backs of the side members, thereby opening the included angle further between the base 16 and back 18. Repositioning the rod 44 across the uppermost notch pair as shown in broken lines in FIG. 3 results in the rod 44 contacting the backs of the side members 34, 36 closer to their pivot points with the extensions 26, 28, thereby closing the angle between the base 16 and back 18.

The base 16 may include provision for removably mounting a computer mouse pad 14 thereto, if so desired. (It should be noted that the mouse pad 14 described herein comprises a rigid sheet of material, rather than being a flaccid pad, although the rigid mouse pad 14 may have such a traction or friction surface removably or permanently applied thereto to facilitate engagement with a computer mouse ball.) Each of the side members 20 and 22 of the base 16 includes an outwardly and downwardly depending flange, respectively 46 and 48, extending therefrom. At least one side member of the base, e.g., the second side member 22, includes at least two keyhole-shaped mouse pad attachment slots 50 disposed through the flange 48. It will be seen that the opposite flange 46 may also include such slots therein to allow the mouse pad 14 to be installed to either side of the base 16 as desired; such an alternative pad installation is indicated in broken lines in FIG. 2. Alternatively, a second mouse pad 14 may be installed in addition to the first pad, to serve as a small writing surface or for other purposes as desired by the user. The mouse pad 14 extends from a base attachment flange 52 normal to the plane of the pad 14, with the flange 52 including at least two mouse pad attachment pins 54 extending therefrom. The pins 54 are shown in broken lines extending from the alternative mouse pad 14 shown to the left in FIG. 2, with the attachment ends of the pins 54 being visible through the mouse pad flange 52 in FIG. 3. Each of the pins 54 has a larger diameter head, with the heads passing through the larger diameter portions of the keyhole slots 50 and the pins sliding downwardly into the narrower portions of the slots 50 to secure the mouse pad 14 removably to the side member 20 or 22 of the base 16.

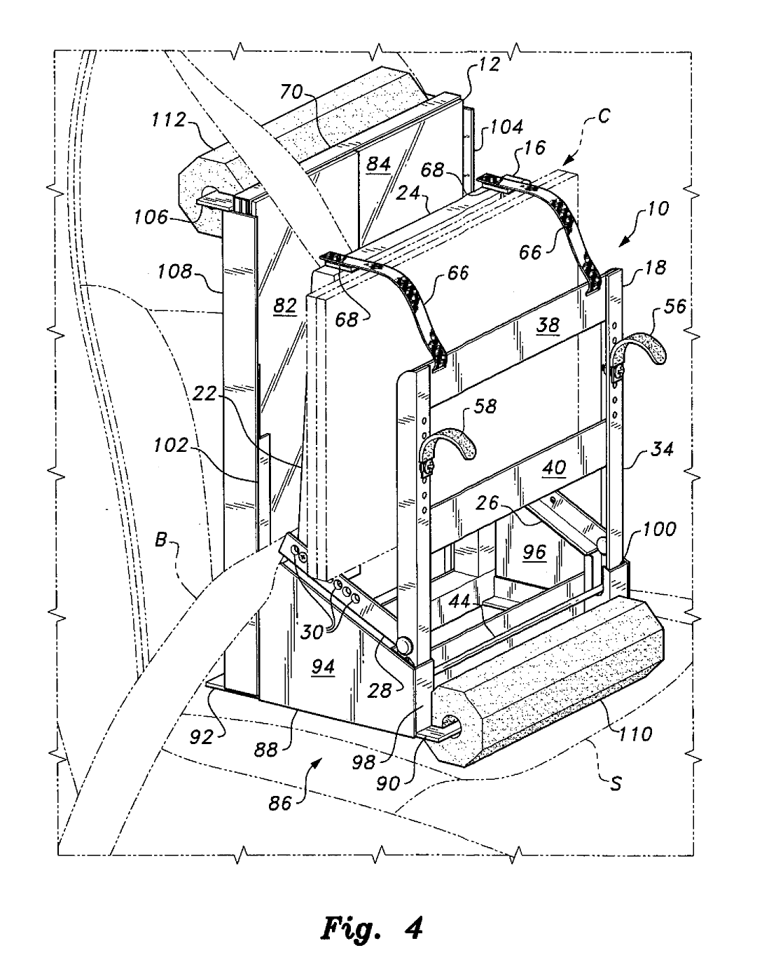

FIG. 1 of the drawings is an exemplary illustration showing the temporary and removable attachment of the multi-purpose mount 10 to the steering wheel W of a motor vehicle, with a portable computer C mounted on the steering wheel mount. Each of the side members 34 and 36 of the back 18 includes a steering wheel attachment, respectively 56 and 58, extending from the upper end thereof; both such attachments 56 and 58 are shown clearly in FIG. 2. These steering wheel attachments 56, 58 preferably comprise padded hooks or curved fingers loosely attached to their respective side members 34 and 36, to allow them to pivot for alignment to various portions of the steering wheel W (shown in broken lines in FIG. 1) as required. Each of the back side members 34 and 36 may be provided with a plurality of holes or passages therethrough, as shown in FIGS. 2 and 4, to allow the steering wheel attachments 56, 58 to be adjustably attached thereto in order to adjust for different steering wheel heights and diameters. A plurality of computer attachment fasteners 60, e.g., hook and loop fabric material or other attachment means as desired, is provided on the side members 20, 22 and/or forward crossmember 24 of the base as shown in FIG. 2, with mating attachment components being provided on the computer C.

FIG. 1 also illustrates the installation of the sunshade 12 over the multi-purpose mount 10 and computer C resting thereon. The sunshade 12 includes a central panel 62 having fastening or attachment means 64 for temporarily and removably securing the sunshade 12 to the back 18 of the multi-purpose mount 10, e.g., hook and loop fastener material, etc. The back 16 includes corresponding straps 66 of suitable material extending from the upper crossmember 38. The straps 66 secure removably to the attachments 64 of the central panel 62 of the sunshade 12, to secure the sunshade to the multi-purpose mount 10. The straps 66 are also used to hold the base 16 and back 18 of the multi-purpose mount 10 closed when the device is not in use, by attaching to corresponding attachments 68 on the forward crossmember 24 of the base 16.

The central panel 62 of the sunshade 12 includes mutually opposed forward and rearward channels, respectively 70 and 72, along the forward and rearward edges thereof. The channels 70, 72 contain laterally opposed first and second lateral panels, respectively 74 and 76, therein, with the panels 74, 76 slidably adjusting laterally inwardly or outwardly to adjust the total width of the sunshade 12 as desired. Each lateral panel has a hinge, respectively 78 and 80, disposed along its outboard edge, with first and second extensions 82 and 84 respectively extending from the hinges 78 and 80. The two extensions 82 and 84 also serve to hold the deployed sunshade 12 open above the computer screen by bracing their rearward edges upon the side members 34 and 36 of the back 18 or upon the steering wheel W.

The multiple panel configuration of the sunshade 12 allows the sunshade 12 to be stored compactly, as shown in FIG. 4. For storage, the two lateral panels 74 and 76 are slid inwardly beneath the central panel 62, and the two extensions 82 and 84 are folded inwardly to lie over their respective lateral panels 74 and 76. The folded sunshade 12 may then be stored compactly in a relatively thin space or slot.

FIG. 4 illustrates a caddy 86 providing for the compact storage of the multi-purpose mount 10, its sunshade 12, as well as a computer C and other accessories. The caddy 86 includes a base 88 having a front crossmember 90, a rear crossmember 92, and mutually opposed first and second sides, respectively 94 and 96, extending upwardly from the front and rear crossmembers 90 and 92. First and second back side member storage receptacles, respectively 98 and 100, are provided at the junctures of the first and second sides 94 and 96 with the front crossmember 90, with the lower portions (i.e., having the adjustment slots and notches 42 therein) of the first and second side members 34 and 36 of the back 18 seating in the receptacles 98 and 100 when the multi-purpose mount 10 is folded. It will be seen in FIG. 4 that the caddy 86 has sufficient depth to allow a personal computer C or the like to be contained within the folded multi-purpose mount 10 while stored in the caddy 86.

Laterally opposed first and second sunshade storage channels, respectively 102 and 104, extend upwardly from the junctures of the first and second sides 94 and 96 with the rear crossmember 92 of the caddy 86, with an upper crossmember 106 joining the upper ends of the channels 102 and 104. These components 102 through 106 form a sunshade storage rack 108. The sunshade 12 may be folded for compact storage as described further above and slid into the channels 102, 104 of the rack 108 for storage with the folded multi-purpose mount 10, generally as shown in FIG. 4. The caddy 86 may be secured in a vehicle seat S or other suitable area by means of a conventional seat belt B or other securing means, as desired. Pads 110 and 112 may be removably placed along the edges of the forward crossmember 90 of the base 88 and the upper crossmember of the sunshade storage rack 106 of the caddy 86, if so desired. A third such pad, not shown, may be installed along the edge of the rear crossmember 92, if so desired.

In conclusion, the multi-purpose mount for a portable computer provides a handy means of supporting and deploying a personal computer or the like from the driver's position in a motor vehicle, enabling the driver or other user to work with such a computer from the driver's position when the vehicle is parked. The multi-purpose mount provides adjustability for various vehicle and computer configurations, and provides sufficient space therein when folded to allow a personal computer with folding screen to be folded and contained therein when not in use. The accompanying caddy provides secure storage for the multi-purpose mount when not in use, as well as storage for any computer that might be contained within the mount and other accessories, e.g., an accompanying sunshade, etc.

It is to be understood that the present invention is not limited to the embodiments described above, but encompasses any and all embodiments within the scope of the following claims.

I claim:

1. A multi-purpose mount for a portable computer, comprising:
a base;
a back pivotally extending from the base;
means for attaching the back to a mounting surface;
a mouse pad removably attached to the base;
a sunshade removably attached to the back; and
a caddy, the base and attached back, the mouse pad, and the sunshade being removably stored within the caddy.

2. The multi-purpose mount for a portable computer according to claim 1, wherein the base has a first side member, a second side member, and a forward crossmember disposed therebetween, the multi-purpose mount further comprising:
a first extension member affixed to the first side member of the base and forming an angle therewith, the back having a first side member pivotally secured to the first extension member;
a second extension member affixed to the second side member of the base, the second extension member being parallel to the first extension member, the back having a second side member pivotally secured to the second extension member and an upper crossmember disposed between the first and second side members, the back and the first and second extension members defining a selectively variable angle therebetween, each of the back side members having a slot with a plurality of angular adjustment notches therein; and
a stop laterally disposed across the first side member and the second side member of the back, the stop being selectively disposed in laterally corresponding ones of the angular adjustment notches of the side members of the back and bearing against the first and second extension members to adjust the angle between the back and the base.

3. The multi-purpose mount for a portable computer according to claim 2 wherein each said extension member has a plurality of attachment passages formed therethrough, whereby each extension member is adjustably secured to the corresponding side member of the base.

4. The multi-purpose mount for a portable computer according to claim 1, wherein:
the base has a first side member, a second side member, and a forward crossmember disposed therebetween, each of the side members having an outwardly disposed flange depending therefrom, at least one of the flanges having a plurality of mouse pad attachment passages disposed therethrough;
the mouse pad has a base attachment flange depending therefrom; and
a plurality of mouse pad attachment pins extend from the base attachment flange of the mouse pad, the pins being selectively inserted in the mouse pad attachment passages of the at least one flange of the base, thereby temporarily and removably securing the mouse pad to the base.

5. The multi-purpose mount for a portable computer according to claim 1, wherein the sunshade has a central panel having a forward channel and a rearward channel, the multi-purpose mount further comprising:
mutually opposed first and second lateral panels slidably extending laterally from the channels of the central panel;
a first extension pivotally and foldably secured to the first lateral panel; and
a second extension pivotally and foldably secured to the second lateral panel.

6. The multi-purpose mount for a portable computer according to claim 1, wherein the caddy has a base having a front crossmember, a rear crossmember, and mutually opposed first and second sides extending upwardly therefrom, a forwardly disposed first back side member storage receptacle extending upwardly from the first side of the caddy, and a forwardly disposed second back side member storage receptacle extending upwardly from the second side of the caddy, the multi-purpose mount further comprising a rearwardly disposed sunshade storage rack extending upwardly from the rear crossmember.

7. The multi-purpose mount for a portable computer according to claim 1, further including:
at least one computer attachment fastener disposed upon the base; and
a plurality of sunshade attachment straps extending from the back.

8. A multi-purpose mount for a portable computer, comprising:
a base having a first side member, a second side member, and a forward crossmember disposed therebetween;
a first extension member affixed to the first side member of the base and forming an angle therewith;
a second extension member affixed to the second side member of the base, the second extension member being parallel to the first extension member;
a back having a first side member pivotally secured to the first extension member, a second side member pivotally secured to the second extension member, and an upper crossmember disposed therebetween, the back and the first and second extension members defining a selectively variable angle therebetween, each of the back side members having a slot with a plurality of angular adjustment notches defined therein;
a stop laterally disposed across the first side member and the second side member of the back, the stop being selectively disposed in laterally corresponding ones of the angular adjustment notches of the side members of the back and bearing against the first and second extension members to adjust the angle between the back and the base; and
means for attaching the back to a mounting surface.

9. The multi-purpose mount for a portable computer according to claim 8, further including:
a mouse pad removably attached to the base;
a sunshade removably attached to the back; and
a caddy, the base and attached back, the mouse pad, and the sunshade being removably stored within the caddy.

10. The multi-purpose mount for a portable computer according to claim 9, wherein:
each of the side members of the base has an outwardly disposed flange depending therefrom, at least one of the flanges having a plurality of mouse pad attachment passages disposed therethrough;
the mouse pad has a base attachment flange depending therefrom; and
a a plurality of mouse pad attachment pins extend from the base attachment flange of the mouse pad, the pins being selectively inserted in the mouse pad attachment passages of the at least one flange of the base, thereby temporarily and removably securing the mouse pad to the base.

11. The multi-purpose mount for a portable computer according to claim 9, wherein the sunshade has a central panel having a forward channel and a rearward channel, the multi-purpose mount further comprising:
mutually opposed first and second lateral panels slidably extending laterally from the channels of the central panel;
a first extension pivotally and foldably secured to the first lateral panel; and
a second extension pivotally and foldably secured to the second lateral panel.

12. The multi-purpose mount for a portable computer according to claim 9, wherein the caddy has a base having a front crossmember, a rear crossmember, and mutually opposed first and second sides extending upwardly therefrom, a forwardly disposed first back side member storage receptacle extending upwardly from the first side of the caddy, and a forwardly disposed second back side member storage receptacle extending upwardly from the second side of the caddy, the multi-purpose mount further comprising a rearwardly disposed sunshade storage rack extending upwardly from the rear crossmember.

13. The multi-purpose mount for a portable computer according to claim 8 wherein each said extension member has a plurality of attachment passages formed therethrough, whereby each extension member is adjustably secured to the corresponding side member of the base.

14. The multi-purpose mount for a portable computer according to claim 8, further including:
at least one computer attachment fastener disposed upon the base; and
a plurality of sunshade attachment straps extending from the back.

15. A multi-purpose mount for a portable computer, comprising:
a base having a first side member, a second side member, and a forward crossmember disposed therebetween, each of the side members having an outwardly disposed flange depending therefrom, at least one of the flanges having a plurality of mouse pad attachment passages disposed therethrough;
a mouse pad having a base attachment flange depending therefrom;
a plurality of mouse pad attachment pins extending from the base attachment flange of the mouse pad, the pins being selectively inserted in the mouse pad attachment passages of the at least one flange of the base, thereby temporarily and removably securing the mouse pad to the base;
a back pivotally extending from the base;
means for attaching the back to a mounting surface;
at least one computer attachment fastener disposed upon the base; and
a plurality of sunshade attachment straps extending from the back.

16. The multi-purpose mount for a portable computer according to claim 15, further comprising:
a first extension member affixed to the first side member of the base and forming an angle therewith;
a second extension member affixed to the second side member of the base, the second extension member being parallel to the first extension member, the back having:
a first side member pivotally secured to the first extension member;
a second side member pivotally secured to the second extension member; and
an upper crossmember disposed therebetween, the back and the first and second extension members defining a selectively variable angle therebetween, each of the back side members having a slot with a plurality of angular adjustment notches therein; and
a stop laterally disposed across the first side member and the second side member of the back, the stop being selectively disposed in laterally corresponding ones of the angular adjustment notches of the side members of the back and bearing against the first and second extension members to adjust the angle between the back and the base.

17. The multi-purpose mount for a portable computer according to claim 16 wherein each said extension member has a plurality of attachment passages formed therethrough, whereby each extension member is adjustably secured to the corresponding side member of the base.

18. The multi-purpose mount for a portable computer according to claim 15, further including:
a sunshade removably attached to the back; and
a caddy, the base and attached back, the mouse pad, and the sunshade being removably stored within the caddy.

19. The multi-purpose mount for a portable computer according to claim 18, wherein the sunshade has a central panel having a forward channel and a rearward channel, the multi-purpose mount further comprising:
mutually opposed first and second lateral panels slidably extending laterally from the channels of the central panel;
a first extension pivotally and foldably secured to the first lateral panel; and
a second extension pivotally and foldably secured to the second lateral panel.

20. The multi-purpose mount for a portable computer according to claim 18, wherein the caddy has a base having a front crossmember, a rear crossmember, and mutually opposed first and second sides extending upwardly therefrom, a forwardly disposed first back side member storage receptacle extending upwardly from the first side of the caddy, and a forwardly disposed second back side member storage receptacle extending upwardly from the second side of the caddy, the multi-purpose mount further comprising a rearwardly disposed sunshade storage rack extending upwardly from the rear crossmember.
